(19) United States
(12) Patent Application Publication
(10) Pub. No.: US 2013/0297522 A1
(43) Pub. Date: Nov. 7, 2013

(54) Consumer-Shipper-Supplier Mediation System and Method

(71) Applicant: TradeMango Solutions, Inc., (US)

(72) Inventors: Andrew Antony Prochazka, Langley (CA); Samuel William Prochazka, Langley (CA)

(21) Appl. No.: 13/663,571

(22) Filed: Oct. 30, 2012

Related U.S. Application Data
(60) Provisional application No. 61/639,189, filed on Apr. 27, 2012.

(51) Int. Cl. G06Q 10/08

(52) U.S. Cl. CPC G06Q 10/083
USPC 705/330

(57) ABSTRACT

A consumer-shipper-supplier mediation system/method that coordinates the ordering/production/delivery of products between consumers and suppliers is disclosed. The system/method allows consumers to aggregate orders for product manufacturing and mediate these product order requests to suppliers and shippers who can then optimize product manufacturing and shipping to meet the aggregated consumer orders. The system/method also permits symmetric operation to allow suppliers to schedule product production and optimize price-per-unit by using PUSH advertising to prospective consumers who have placed tentative orders for products that have yet to be manufactured or are not yet needed. In some preferred embodiments the mediation system/method incorporates a shipping interface to permit shippers to be fully integrated within the consumer-shipper-supplier commerce chain. The system/method in some preferred embodiments matches consumer-shipper-supplier constraints while simultaneously maximizing supplier-shipper pricing margins and minimizing consumer delivered product costs.

### CROSS REFERENCE TO RELATED APPLICATIONS

Applicants claim benefit pursuant to 35 U.S.C. §119 and hereby incorporate by reference Provisional patent application for “A SYSTEM AND METHOD FOR SELLING MASS PRODUCTION RUNS”, Ser. No. 61/639,189, filed with the USPTO on Apr. 27, 2012.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The invention relates to buying, selling and delivering production orders and parts thereof using electronic networks such as the Internet. In particular, the invention relates to the mediation and matching of the respective constraints of buyers, suppliers, and deliverers by means of the Internet.

### PRIOR ART AND BACKGROUND OF THE INVENTION

### Prior Art

Buying products from businesses with websites on the Internet has become very common. Despite this new sales channel, the conventional retail model and supply chain has not changed. Before a buyer finally receives a purchased product from a retailer, whether that retailer be bricks-and-mortar or Internet-based, that product has usually moved through several layers of supply chain and resulting profit-taking. These layers of supply and delivery typically include production, distribution, wholesale, retail and transportation therebetween.

Previously performed by conventional bricks-and-mortar retailers, some Internet merchants have developed technology to aggregate buyers to form larger buying groups such that their collective buying power can be used to achieve better pricing from various layers of the supply chain (U.S. Pat. No. 7,747,473). Even in these cases the typical model of profit-taking between the various conventional layers of the supply and delivery chain is maintained.

Several companies have extended this aggregate purchasing principle to aggregate demand for new products, most commonly works-of-art (U.S Patent Application Publication 2009/0006184, Ser. No. 12/134,033). In such cases, demand for a new product, such as a music album, is aggregated and used to pay for production of that new product, such as music by a given artist. Cases like this fall outside the scope of the present invention in that they seek to aggregate demand for product designs that do not exist at the time of purchase.

Whereas present technology seeks to make the existing supply chain more efficient, the present invention provides a novel way to coordinate combinations of buyers, suppliers, and deliverers to identify paths from production to fulfillment.

### DEFICIENCIES IN THE PRIOR ART

In general, the prior art as detailed above describes constraint matching in different ways between sellers and buyers, but does not describe constraint matching with an independent third party such as a shipping entity. In some cases, the prior art describes constraints involving shipping, but only insofar as they are constraints belonging to the selling entity.

Shkedy (U.S. Pat. No. 6,260,024) and Walker et al. (U.S. Pat. No. 6,466,919) describe systems and methods for binding buyer conditional purchase offers with seller conditional sales offers, each offer subject to conditions. The invention matches the constraints between only two parties, namely the buyer and seller, thereby requiring one or other of the parties to specify the fulfillment constraints. The invention applies well to intangible products, like hotel reservations and flight tickets, not requiring delivery, but makes no mention of a third party involved in fulfillment of tangible items. The invention teaches that only buyer and seller constraints are required to transform a conditional purchase offer into a binding purchase agreement.

Walker et al. (U.S. Pat. No. 7,124,107) describe a similar method and system further teaching that a seller specifies shipping and fulfillment constraints to facilitate a transaction between a group of buyers and a seller. Walker et al. is referenced by Tubeville et al.'s “Distributed-user shipping system” (U.S. Pat. No. 8,005,727), which describes a method of collecting shipping constraints from multiple shipping providers. The combination teach a mechanism by which a seller can create shipping constraints from a constraints database, but teaches away from an automated constraints matching and mediation system between three unrelated parties described herein.

J. Mesaros (U.S. Pat. No. 7,747,473) describes an order aggregation system for partial orders that together constitute a full production run. The invention teaches nothing of mediation of constraints between the three parties involved in a transaction for tangible goods. Furthermore, this invention optimizes production runs rather than matching constraints that may form suboptimal runs, as is possible in the present invention.

Van Horn et al. (U.S. Pat. No. 6,604,089), Pallakoff (U.S. Pat. No. 6,269,343), Chung et al. (U.S. Pat. No. 7,672,897), and Mesaros (U.S. Pat. Nos. 7,181,419, 7,689,469, 7,689,463) describe similar systems and methods in which an online buying group is formed for the purpose of purchasing a particular product meeting a plurality of conditions. Like those above, the invention mediates conditions between only the buyer and seller, again neglecting to address delivery constraints of a third party.

Leach et al. (U.S. patent application Ser. Nos. 12/134,033, 11/849,905) describes systems and methods that sell futures contracts for products. Like most prior art analyzed, these applications fail to mediate constraints between the three parties described in the present invention.

Mason (U.S. patent application Ser. No. 12/776,028) and his company Groupon, Inc. describe order aggregation in combination with redeemable reward points. The company's published material on Groupon.com, as well as this application neglect to mediate between the three parties described in the present invention.

Overall, the prior art is deficient in the following ways:
It does not provide a method to facilitate constraint matching between buyers, sellers, and fulfillment intermediaries or other independent third parties required by transactions involving purchase of tangible items.
It does not provide a system capable of collecting constraints other than those belonging to either the buyer or the seller.

While some of the prior art may teach some solutions to these problems, the core issues of properly mediating consumer-shipper-supplier constraints to identify complete commerce paths has not been addressed by the prior art.

### OBJECTIVES OF THE INVENTION

Accordingly, the objectives of the present invention are (among others) to circumvent the deficiencies in the prior art and affect the following objectives:
(1) Provide for a consumer-shipper-supplier mediation system and method that permits buyers to purchase and receive products from a supplier at a price approximately equal to the supplier's cost of production rather than at a higher price.
(2) Provide for a consumer-shipper-supplier mediation system and method that does not require that a product be stocked or produced before a consumer can purchase it.
(3) Provide for a consumer-shipper-supplier mediation system and method that does not require the consumer or supplier to engage a shipper before a product is sold to a consumer.
(4) Provide for a consumer-shipper-supplier mediation system and method that permits a supplier to sell Mass Production Runs (MPRs) of products to a larger market than just consumers capable of making purchases large enough to meet or exceed that supplier's Minimum Order Quantity (MOQ).
(5) Provide for a consumer-shipper-supplier mediation system and method that permits a consumer to purchase small quantities of products directly from suppliers rather than wholesalers or other supplier entities.
(6) Provide for a consumer-shipper-supplier mediation system and method that permits a consumer to purchase small quantities of a product at a per-unit price equal or close to that of the per-unit price of a complete mass production run of that product.
(7) Provide for a consumer-shipper-supplier mediation system and method that permits aggregation of shipments containing products from unaffiliated suppliers destined to unaffiliated buyers.
(8) Provide for a consumer-shipper-supplier mediation system and method that allows a supplier to maintain its Minimum Order Quantity (MOQ) when selling to consumers with smaller buying power.
(9) Provide for a consumer-shipper-supplier mediation system and method that allows a shipper to maintain its minimum shipping quantity when shipping goods from suppliers to consumers.
(10) Provide for a consumer-shipper-supplier mediation system and method that allows a supplier to increase its per-unit price while maintaining a better consumer price than wholesalers, distributors, retailers, or other supplier entities.
(11) Provide for a consumer-shipper-supplier mediation system and method that permits mass produced products to be shipped directly to consumers without requiring storage and handling costs typically associated with wholesale/retail transactions.
(12) Provide for a consumer-shipper-supplier mediation system and method that obviates the need for suppliers to maintain an inventory of their products.
(13) Provide for a consumer-shipper-supplier mediation system and method that allows suppliers to increase their Minimum Order Quantity (MOQ) while decreasing their cost-per-unit of production.
(14) Provide for a consumer-shipper-supplier mediation system and method that allows resellers to sell products before ordering the products from suppliers.
(15) Provide for a consumer-shipper-supplier mediation system and method that allows demand for a product to be assessed before ordering or manufacturing the product.
(16) Provide for a consumer-shipper-supplier mediation system and method that allows suppliers to minimize wasted inventory and/or production capacity.
(17) Provide for a consumer-shipper-supplier mediation system and method that optimizes shipping efficiency.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention may be generally described as a system/method for mediating demand flow between consumers, shippers and suppliers. The system/method provides a unified interface to consumers/shippers/suppliers to allow each resource entity to describe their operational constraints. These operational constraints may include such things as trigger purchase price, Minimum Order Quantity (MOQ), price-per-unit, cost-per-unit, minimum cargo transport size, individual consumer transportation charges, etc., that are associated with each of the consumer/shipper/supplier entities. Once operational constraints are matched, they are mediated using a mediation matching algorithm that attempts to identify product flow paths that may be optimized for given constraints, for example the overall financial gain for each of the affected commerce chain entities.

Most commonly, this optimization process permits the consumer to obtain the lowest price for a product consistent with optimal product manufacturing gain for the supplier and optimal financial gain for the shipper. Utilization of this globally optimized commerce chain mediation permits suppliers to maximize overall product manufacturing gains while simultaneously allowing consumers to achieve product price reductions not possible on the wholesale market. Increased product flow resulting from this commerce chain optimization also results in more efficient transportation costs for shippers. Such optimization yields savings in transportation energy costs, reduces risk of less-than-full shipments, and generally increases profitability of a shipper.

Less commonly, this optimization process permits the optimization of different constraints, such as delivery time to a consumer. In this case, the consumer receives a product in a much shorter time at the expense of optimizing other constraints, such as price.

### BRIEF DESCRIPTION OF THE DRAWINGS

For a fuller understanding of the advantages provided by the invention, reference should be made to the following detailed description together with the accompanying drawings wherein:

FIG. 1 illustrates a general preferred exemplary system embodiment of the present invention;

FIG. 2 illustrates a detailed preferred exemplary system embodiment of the present invention;

FIG. 3 illustrates a preferred exemplary method embodiment of the present invention;

FIG. 4 illustrates a preferred exemplary method embodiment of the present invention incorporating supplier PUSH advertising;

FIG. 5 illustrates an exemplary commerce chain entry (CCE) data structure associated with the commerce chain database (CHD);

FIG. 6 illustrates an exemplary commerce chain entry (CCE) data structure associated with the commerce chain database (CHD) incorporating chained CCE data structures;

FIG. 7 illustrates an exemplary commerce chain entry (CCE) data structure associated with the commerce chain database (CHD) incorporating fractionalized CCE data structures;

FIG. 8 illustrates an exemplary commerce chain entry (CCE) data structure associated with the commerce chain database (CHD) incorporating nested CCE data structures;

FIG. 9 illustrates an exemplary product flow for an application implementing a selling system for Mass Production Runs (MPRs);

FIG. 10 illustrates a preferred exemplary system embodiment of the present invention as applied to an apparatus for selling Mass Production Runs (MPRs);

FIG. 11 illustrates a preferred exemplary method embodiment of the present invention incorporating a matching engine method;

FIG. 12 illustrates a preferred exemplary method embodiment of the present invention incorporating a matching engine method;

FIG. 13 illustrates a preferred exemplary consumer user interface (CUI) useful in some preferred embodiments of the present invention depicting an exemplary supplier complement of products ready for purchase;

FIG. 14 illustrates a preferred exemplary consumer user interface (CUI) useful in some preferred embodiments of the present invention depicting context-sensitive advertising;

FIG. 15 illustrates a preferred exemplary consumer user interface (CUI) useful in some preferred embodiments of the present invention depicting context-sensitive advertising detail;

FIG. 16 illustrates a preferred exemplary consumer user interface (CUI) useful in some preferred embodiments of the present invention depicting real-time pricing, delivery, and shipping container utilization statistics.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a CONSUMER-SHIPPER-SUPPLIER MEDIATION SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Internet Communication not Limitive

The present invention anticipates that a wide range of communication methodologies may be utilized to affect a specific implementation of the present invention. While the present invention specifically anticipates that the use of the Internet for most applications, the present invention makes no limitation on the type of communication technology or computer networking that may be used. Thus, the terms “communication network”, “computer network”, and/or “Internet” are to be given the broadest possible definitions within the scope of the present invention.

### Consumer/Supplier not Limitive

The present invention description generally depicts a model where a “consumer” interacts with a “supplier” to negotiate a product purchase via a “mediator”. This model anticipates that a “consumer” may be a “supplier” to yet another person in the product supply chain. Thus, within this context the terms “consumer” and “supplier” should be given their broadest possible interpretations consistent with the invention application context.

### Manufacturer/Producer not Limitive

The present invention makes no distinction between the terms “manufacturer”, “producer”, and “supplier”, of a product and these terms and like functional equivalents are used interchangeably in this document.

### Shipper/Deliverer not Limitive

The present invention makes no distinction between the terms “shipper”, “deliverer”, and “transporter” of a product and these terms and like functional equivalents are used interchangeably in this document.

### Consumer/Buyer not Limitive

The present invention makes no distinction between the terms “consumer”, “customer”, “purchaser”, and “buyer” of a product and these terms and like functional equivalents are used interchangeably in this document.

### Mass Production Run not Limitive

The present invention in many preferred embodiments may be used to interface consumers to a “mass production” commerce chain by permitting individual consumers or groups of individual consumers to collectively access “mass production runs” from one or more suppliers. Within this application context the terms “mass production” and “mass production run (MPR)” should be given their broadest possible interpretation consistent with the application context. In many circumstances the MPR may be related to a minimum production quantity or a minimum quantity that can be efficiently produced by the supplier. The exact value of this term will necessarily vary with the application context.

### Constraints not Limitive

The present invention describes various exemplary “constraints” that may be applied to suppliers, shippers, and/or consumers. These constraints are only exemplary of various constraint types that may be used to create supplier, shipper and consumer transactions through the mediation system and method as taught by the present invention.

### System Overview (0100)

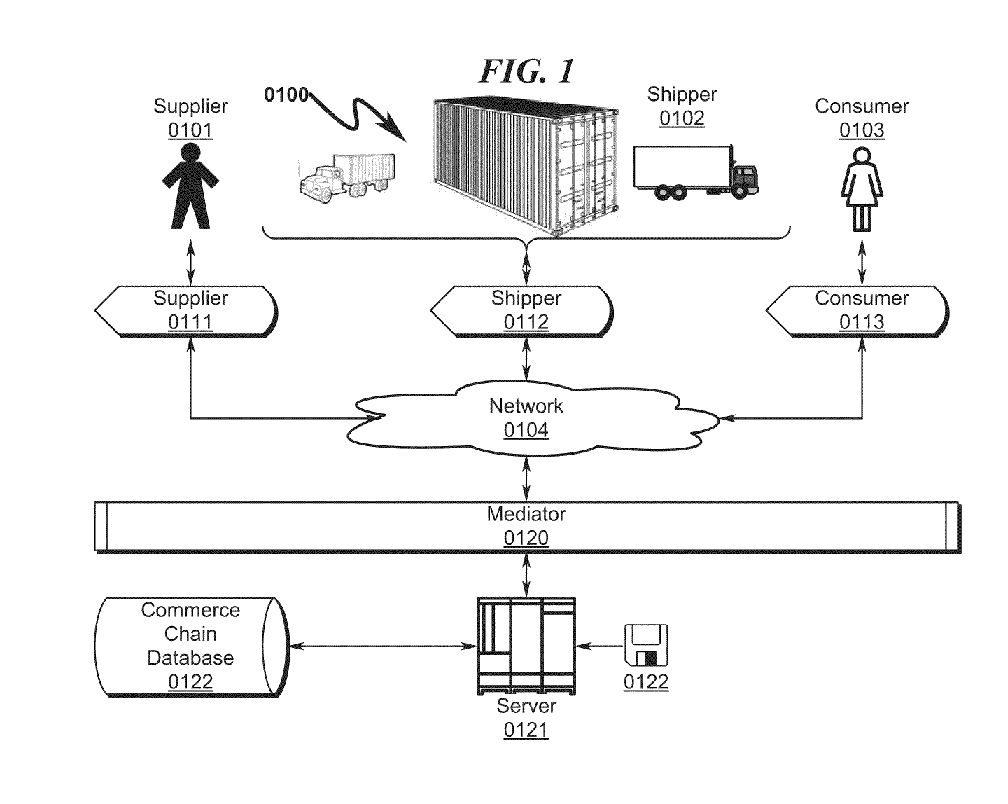

The present invention in a system embodiment may be broadly described as depicted in FIG. 1 (0100) wherein a product supply chain between a supplier (0101), shipper (0102), and consumer (0103) is managed by a mediator process (0120) operating in the context of a computing device (0121) running software loaded from a computer readable medium (0122). The supplier (0101), shipper (0102), and consumer (0103) interface with the mediator (0120) with one or more respective user interfaces (0111, 0112, 0113) to define constraints on their desired operation and goals for optimal financial gain within the product supply chain. These constraints are managed by the mediator (0120) and matched to form “commerce chains” that link production from the supplier (0101), transportation from the shipper (0102), and consumption by (and/or delivery to) the consumer (0103).

The supplier (0101), shipper (0102), and consumer (0103) entities may represent one or more other commerce chains and the commerce chain linkages may be daisy-chained and/or branched in a daisy-chained fashion to support multiple levels of product distribution. For example, single/multiple suppliers (0101) may interact with single/multiple shippers (0102) to supply single/multiple consumers (0103). Suppliers (0101) may be considered as “consumers” of another product delivery chain.

### System Data Flow (0200)

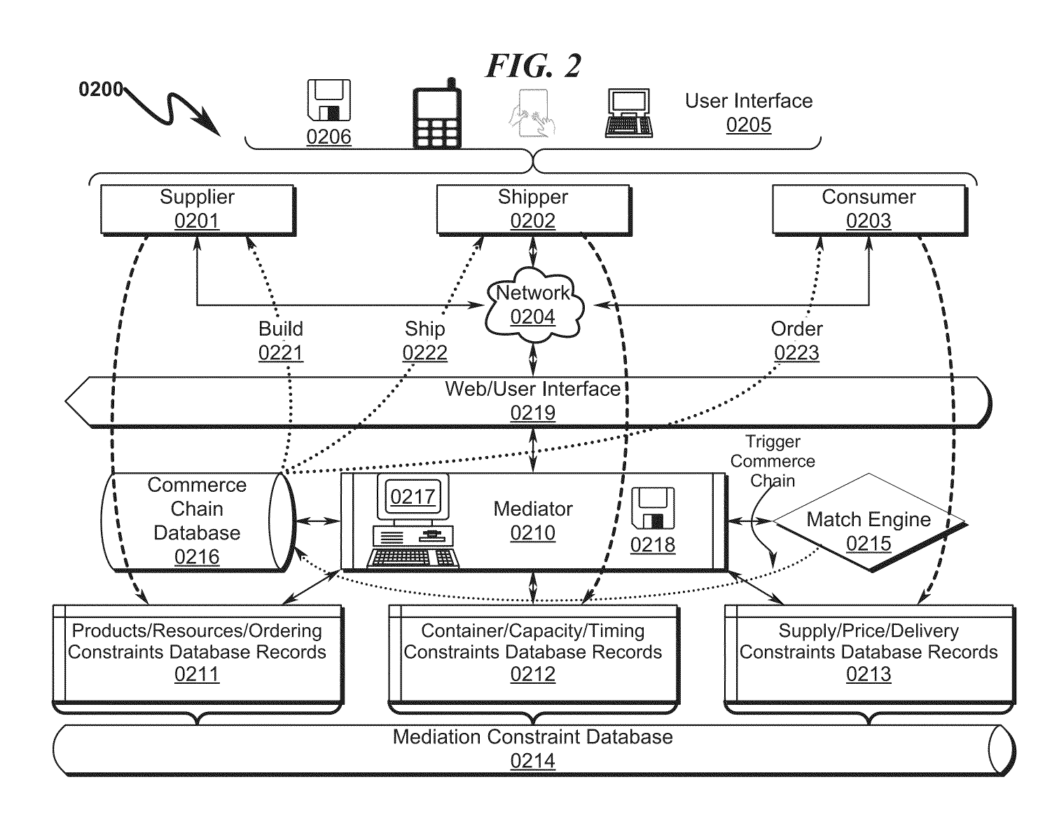

As depicted in FIG. 2 (0200), the data flow in an exemplary system embodiment is as follows. Suppliers (0201), shippers (0202), and/or consumers (0203) interact over a computer network (0204) with a mediator (0210) operating on a computing device (0217) under control of software read from a computer readable medium (0218). This supplier (0201)/shipper (0202)/consumer (0203) interaction occurs via a web/user interface (0219) that acts as a user presentation layer to the mediator (0210) via the network (0204) through a variety of user interface computing devices (0205) operating under control of software read from a computer readable medium (0206).

Upon interaction via the web/user interface (0219), the suppliers (0201), shippers (0202), and/or consumers (0203) create constraint records (0211, 0212, 0213) within a mediation constraint database (0214) under control of the mediator (0210) that define operating parameters for the participating commerce chain entities (supplier (0201), shipper (0202), and/or consumer (0203)). These constraint records (0211, 0212, 0213) are then inspected by the mediator (0210) to determine if constraints defined in the records (0211, 0212, 0213) can be reconciled and matched (0215) between the remaining constraint records (0211, 0212, 0213), and if so, a commerce chain database (0216) is updated with a “commerce chain” record of potential resource links between suppliers (0201), shippers (0202), and/or consumers (0203) to define a “commerce chain” that is eligible for activation.

Once the commerce chain database (0216) has been updated with the formed and activated commerce chain record, build (0221), ship (0222), and/or order (0223) directives are sent to the corresponding suppliers (0201), shippers (0202), and/or consumers (0203) to trigger execution of the commerce chain. This results in execution of supply generation by the supplier (0201), shipment of the completed order by the shipper (0202), and order completion by the consumer (0203).

### Method Overview (0300)

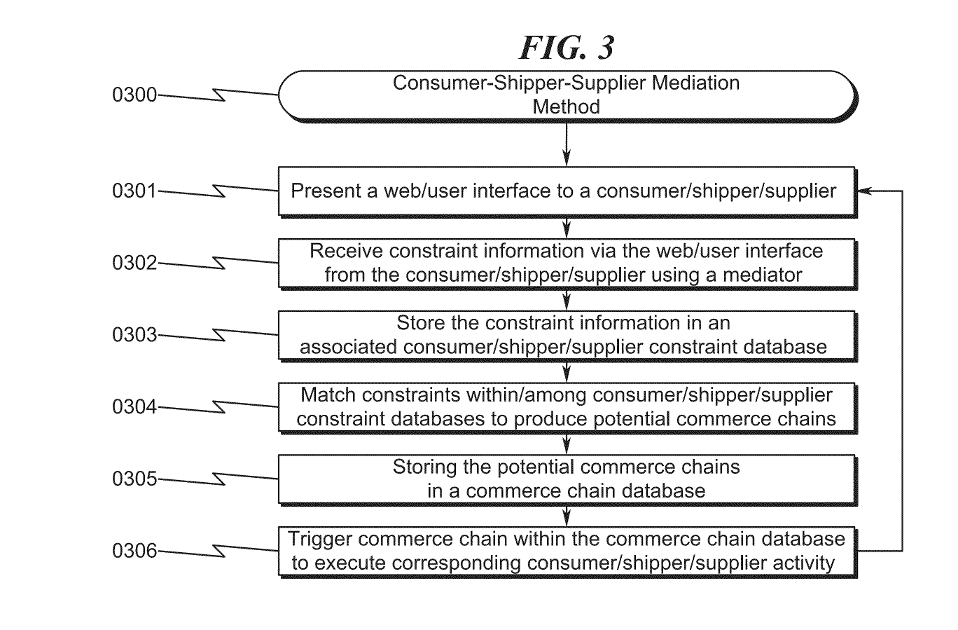

The present invention in a method embodiment may be generally described by the flowchart of FIG. 3 (0300), wherein the consumer-shipper-supplier mediation method comprises the following steps:
(1) presenting a web/user interface to a consumer/shipper/supplier (0301);
(2) receiving constraint information from the consumer/shipper/supplier using a mediator via the web/user interface (0302);
(3) storing the constraint information in an associated consumer/shipper/supplier constraint database (0303);
(4) matching constraints within and among the consumer/shipper/supplier constraint databases to produce potential commerce chains (0304);
(5) storing the potential commerce chains in a commerce chain database (0305); and
(6) triggering a commerce chain within the commerce chain database to execute corresponding consumer/shipper/supplier activity (0306);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Note that within this exemplary method embodiment one preferred alternative allows optional recursion relating to suppliers (who may act as consumers within another commerce chain) and/or consumers (who may act as suppliers within another commerce chain). Yet another method variant uses PUSH advertising from the supplier to the consumer as part of the triggered activity in step (6) (0306). Yet another method variant uses a supplier/shipper/consumer intermediary or agent acting on its behalf to receive constraint information as part of the receipt of constraint information in step (2) (0302).

### Exemplary PUSH Advertising System Embodiment (0400)

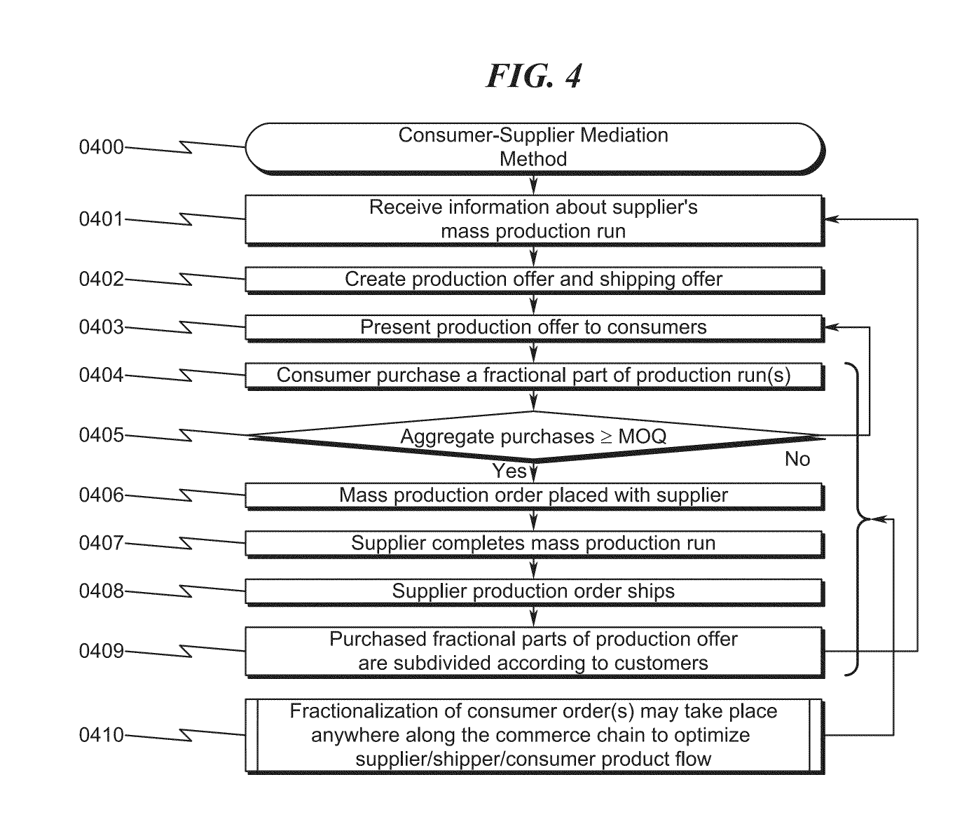

The present invention may be advantageously applied to an application in which the supplier may PUSH advertising to a consumer to trigger supplier production as generally illustrated in the method flowchart of FIG. 4 (0400), wherein the method describes a technique for selling Mass Production Runs (MPRs) by the supplier. The general method involves the following steps:
(1) The supplier provides information about at least one Mass Production Run (MPR) (0401). In some embodiments information received in step (0401) may include product specifications, production lead time, Minimum Order Quantity (MOQ), price per unit or other relevant supplier or product information. In some embodiments at least one product is offered in at least one Mass Production Run (MPR). In some embodiments the received Minimum Order Quantity (MOQ) in the MPR (0401) may be a function of several variables that may include one or more of the following: volume of product, type of product, volume of shipping container, number of products and other relevant variables. In some embodiments the supplier may not be the producer of the product. In some embodiments, this information may be received through a third party such as a supplier's selling agent or as a buyer's purchasing agent.
(2) The information about a supplier's Mass Production Run (MPR) (0401) is used to create a production/shipping offer (0402). The production offer can be purchased in fractional parts equal to or lower than the Minimum Order Quantity (MOQ) originally received from the supplier (0401). In some embodiments the production offer (0402) may include product specifications, production lead time, Minimum Order Quantity (MOQ), price per unit or other relevant supplier or product information. In some embodiments where a Mass Production Run (MPR) is composed of more than one product, the Minimum Order Quantity (MOQ) of each product may be a function of the purchased fractional parts of the production offer. Within this context the shipping constraints may be generated to provide the consumer with a matrix of possible overall product costs that include shipping parameters.
(3) The production offer is presented to at least one buyer/consumer (0403). In some embodiments creation of the production offer (0402) and receipt of information about a supplier's Mass Production Run (MPR) (0401) may be combined. In some embodiments the production offer may change as fractional parts of the production offer are purchased.
(4) At least one buyer purchases a fractional part of at least one production offer (0404).
(5) The purchased fractional parts of production offers are aggregated (0405) until their aggregate reaches the Minimum Order Quantity (MOQ) originally specified by the supplier (0401).
(6) A Mass Production Run (MPR) order based on the original supplier's Mass Production Run (MPR) information is placed with that supplier (0406). In some embodiments the order may be placed before the aggregate (0405) is reached. In some embodiments the order or part thereof may be placed with a different supplier.
(7) The supplier or at least one associated entity mass produces the order (0407). In some embodiments the order may be supplied from inventory, from at least one other source, or from a combination of sources.
(8) Once produced the supplier or at least one associated entity ships the order (0408). In some embodiments buyers may coordinate shipment of their purchased fractional parts of the production offer. In some embodiments an intermediary may be involved in coordinating shipment of the order. In some embodiments the order may be shipped from one or more sources in one or more shipments to one or more locations by one or more entities.
(9) The order is subdivided and the purchased fractional parts of the production offer are delivered to their respective buyers (0409). In some embodiments the supplier or at least one associated entity may subdivide the order and ship directly to buyers. In some embodiments the buyer may coordinate subdivision and receipt of their respective purchased fractional parts of the production offer. In some cases buyers may sell or otherwise assign to an alternate entity one or more of their purchased fractional parts of the production offer before the order is subdivided. In some embodiments orders may be subdivided before they are shipped (0408).
(10) Within the commerce chain, fractionalization of consumer order(s) may take place anywhere along the commerce chain to optimize supplier/shipper/consumer product flow (0410). That is, a “subdivision” may take place at any state in the commerce chain (e.g., optimization may require that numerous suppliers be used or that numerous shipment channels be used).
   One skilled in the art will recognize that the steps detailed above are exemplary of the method and may be rearranged, augmented, reduced, or otherwise modified according to specific application of the invention.

### Exemplary Commerce Chain Database (CHD) (0500)

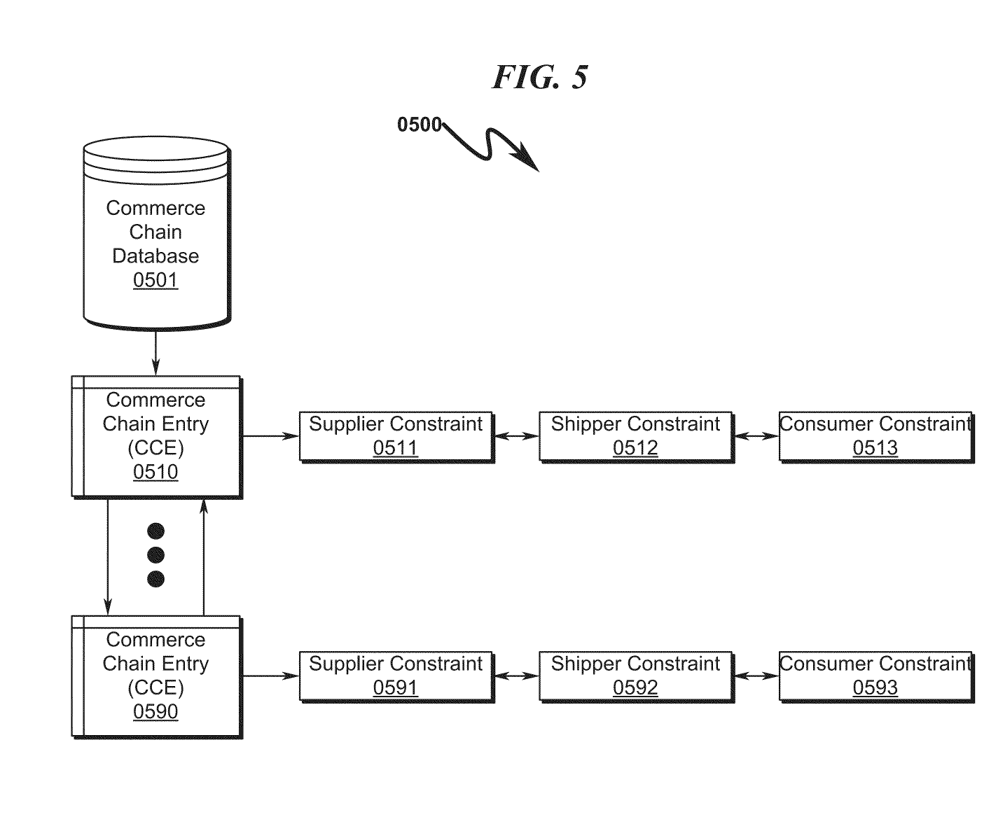

Many preferred embodiments of the present invention will incorporate a commerce chain database (CHD) that stores lists of potentially active commerce chains relating to suppliers, shippers, and/or consumers. As generally illustrated in FIG. 5 (0500), this CHD data structure (0501) may take the form of a linked list (preferably double-linked) in which the CHD (0501) comprises commerce chain entries (CCE) (0510, 0590) that are linked together to form a list of possible activities that satisfy overall supplier/shipper/customer constraints. As illustrated in this example, the simplest form of the CCE (0510, 0590) is in the form of a linked list (preferably double-linked) of supplier-shipper-consumer constraints (0511, 0512, 0513) (0591, 0592, 0593) that represent consistent constraints that when linked together represent a coherent supply chain from supplier-to-shipper-to-consumer.

This example represents a simple form of the CCE linkage, in that the CCE elements form a supplier/shipper/consumer triple. As mentioned before, in some circumstances the shipper and their associated function is integrated in to the supplier and/or consumer (or eliminated altogether) and therefore a supplier/consumer doublet may be used to represent the CCE. It should be noted that in some circumstances the supplier/shipper/consumer may have NULL constraints within their constraint profile, and thus this scenario may act as a permissive nullity when generating and activating the CCE list. This might happen, for example, if the consumer is only interested in receiving a product at the lowest possible cost, but makes no constraints on the delivery date, actual cost, or other supplier/shipper production/delivery constraints.

### Exemplary Chained Commerce Chain Entries (CCE) (0600)

As mentioned previously, the present invention anticipates situations where a “consumer” may actually be a “supplier” to a downstream commerce chain, and symmetric situations where a “supplier” may be a “consumer” to an upstream commerce chain. This “chaining” of CCEs permits the concept of fractionalized production and consumption to be generalized to broader situations than possible using simple supplier/shipper/consumer triplets.

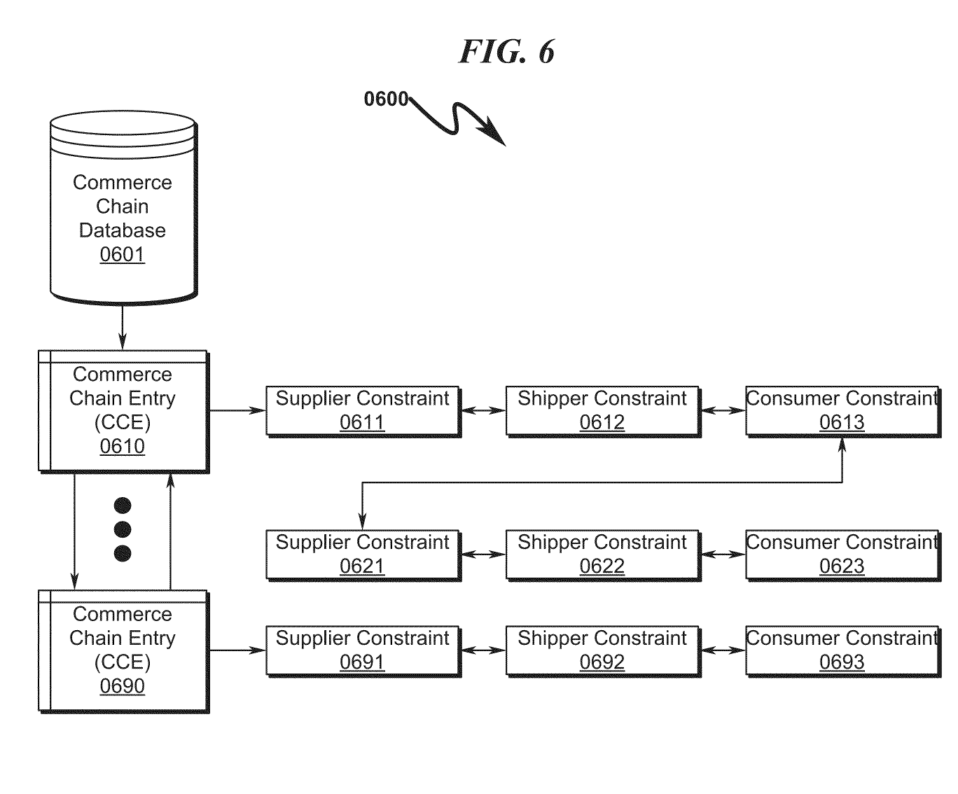

As generally illustrated in FIG. 6 (0600), this CCE chaining is accomplished by providing internal linked list pointers (preferably doubly linked) between a “terminal” consumer constraint (0613) CCE and a corresponding “downstream” supplier constraint (0621) CCE data structure. While not specifically illustrated, loops within this CCE structure are possible, such that a linkage between the “end” consumer constraint (0623) and the “head” supplier constraint (0611) is permissible. In this scenario, triggering of activity within the constraint chain can be processed iteratively, with supplier production flowing to terminal consumer and then the results of this flowing back to the “head” supplier.

### Exemplary Fractionalized Commerce Chain Entries (CCE) (0700)

As mentioned previously, the present invention anticipates situations where a supplier/shipper/consumer may be “fractionalized” within the scope of the mediation system/method to permit decimation of a given constraint or resource among a number of supplier/shipper/consumer entities. For example, multiple suppliers may collaborate with multiple shippers to supply multiple customers in a collaborative production/shipping/receipt network in which all the entities are not necessarily aware of the other participants but rather are driven by their own optimal economic benefit. In other similar examples, the entities are not necessarily aware of the other participants but are driven by different motivations including time-to-market, liquidation, speed-of-delivery, or other motivating factors.

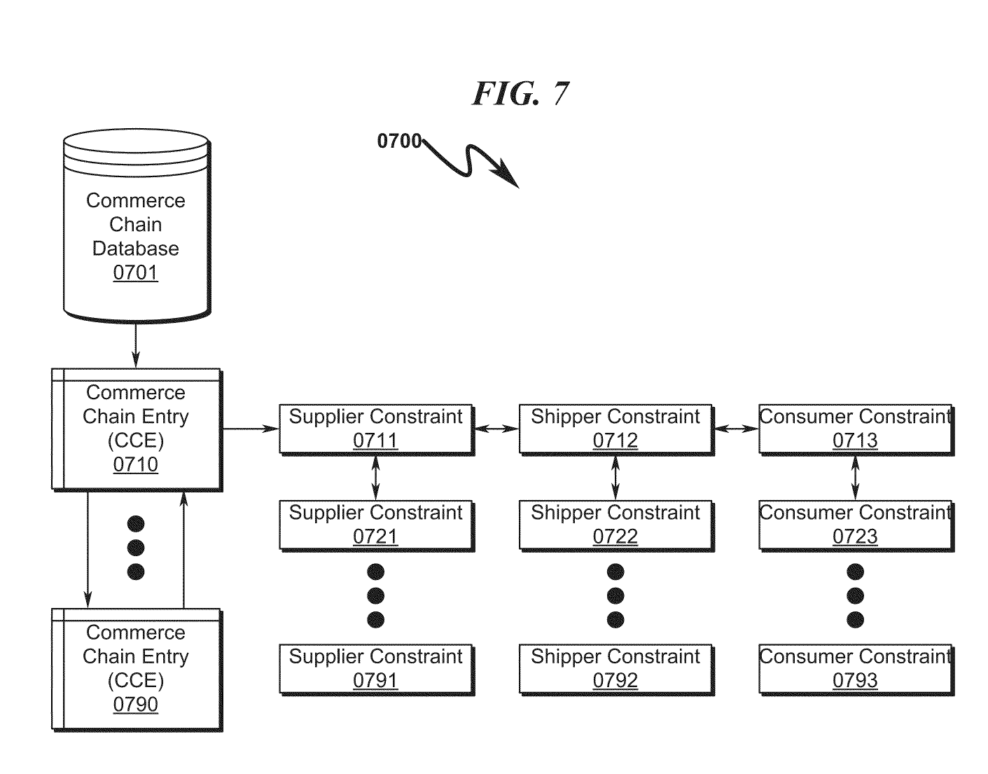

As generally illustrated in FIG. 7 (0700), this may result in CCE entries (0710) that incorporate linked lists of suppliers (0711, 0721, 0791), shippers (0712, 0722, 0792), and/or consumers (0713, 0723, 0793). Thus, for each of these fractionalized lists (0711, 0721, 0791) (0712, 0722, 0792) (0713, 0723, 0793) the flow of product may be divided among various suppliers, shippers, and/or consumers to optimize economic benefit for the overall flow of commerce.

In this scenario, triggering of activity within the constraint chain activates all functional elements within a particular fractionalized list to permit maximum product flow from supplier to consumer.

### Exemplary Hybrid Commerce Chain Entries (CCE) (0800)

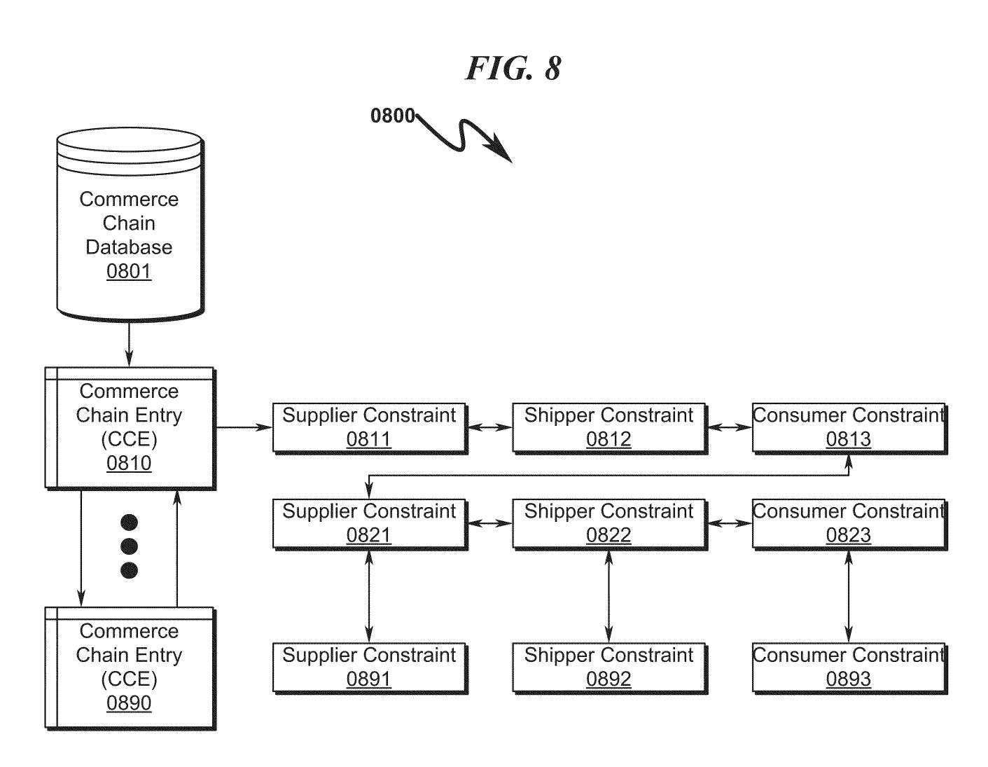

As generally illustrated in FIG. 8 (0800), the techniques described in FIG. 4 (0400)-FIG. 7 (0700) may be combined to permit a nested chain of CCE elements, wherein each supplier, shipper, and consumer may be represented by a tree of one or more suppliers, shippers, and/or consumers. Within this example, the first constraint tuple (0811, 0812, 0813) represents a conventional supplier/shipper/consumer constraint chain; the second constraint tuple (0821, 0822, 0823) represents a chained supplier/shipper/consumer constraint chained extension; and the third constraint tuple (0891, 0892, 0893) represents a fractionalized augmentation of the prior constraints (0821, 0822, 0823). One skilled in the art of computer science will no doubt realize that there are innumerable combinations of these data structures that can form viable constraint trees capable of execution by the mediation system/method described herein.

### Exemplary Mass Production Run Selling System

### Product/Data Flow (0900)

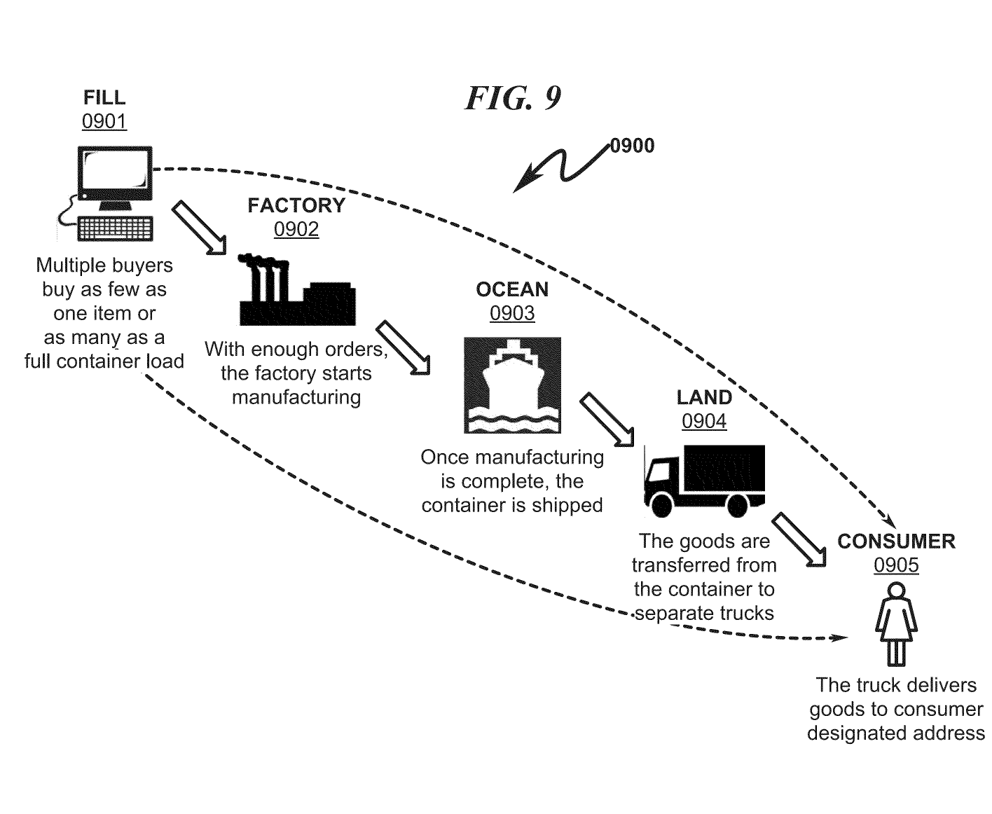

While the present invention may be implemented within many application contexts, one preferred context involves a system for selling Mass Production Runs (MPRs). As generally illustrated in FIG. 9 (0900), the information and product flow in this exemplary application is as follows:
A consumer is permitted to buy as few as one item or as many as a full container load of a particular product (0901);
When enough orders have been accumulated the factory starts manufacturing the product (0902);
Once manufacturing is complete, the filled shipping container is shipped (0903);
The goods are transferred from the shipping container to a delivery truck (0904);
The delivery truck delivers the manufactured product to the consumer at the designated address (0905).
   One skilled in the art will recognize that this commerce chain may have a wide variety of variations based on specific application context.

### MPR System Embodiment (1000)

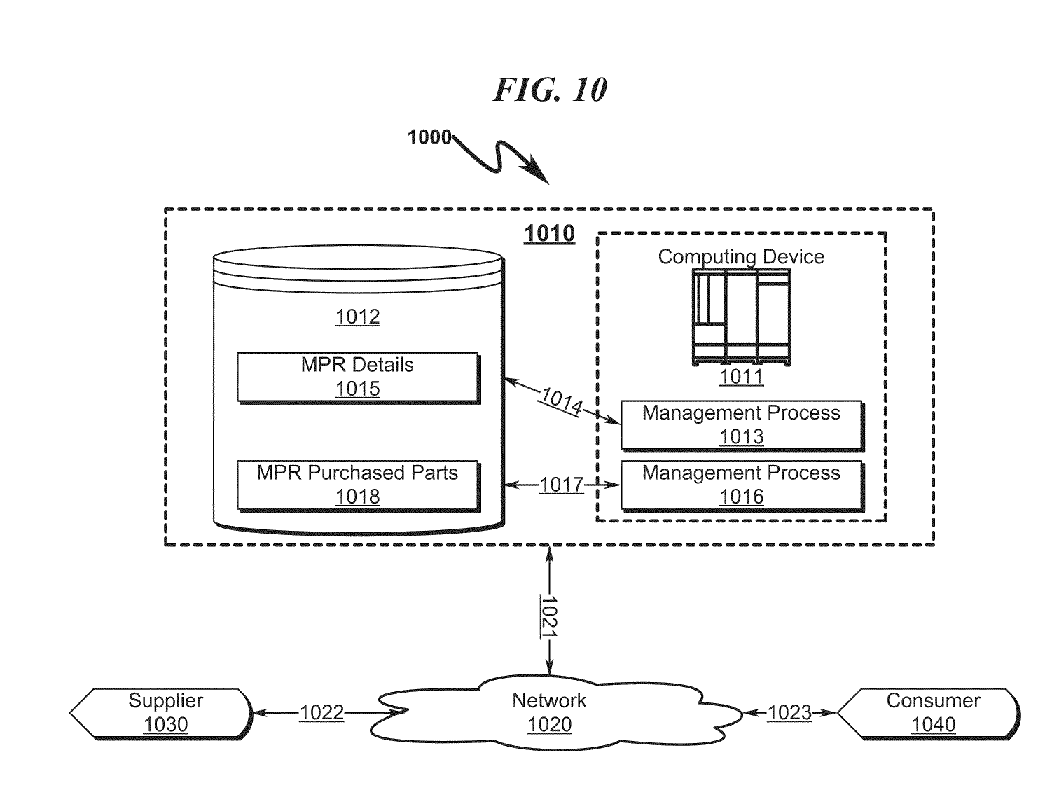

As generally illustrated in FIG. 10 (1000), a system for selling Mass Production Runs (MPRs) (1010) typically includes at least one computer system executing computer readable program code (1011), computer usable memory medium (1012), and external network connection (1021) to the Internet (1020). Supplier (1030) connects to the system (1010) via a network connection (1022) to the Internet (1020). Buyer (1040) connects to the system (1010) via a network connection (1023) to the Internet (1020). In some embodiments buyer (1040) or supplier (1030) may connect to the system (1010) via means other than the Internet (1020) including directly, via a local network or electronic connection, via a human interface, via fax, via mail, or via telephony, or indirectly through a human or machine proxy. In some embodiments buyer (1040) is one or more buyers and supplier (1030) is one or more suppliers. In some embodiments management processes (1013) and (1016) may be the same process or may be subdivided into more than one process.

System (1010) includes process-memory interface (1014) that allows management process (1013) to access, analyze, add, delete, and modify records of Mass Production Runs (MPRs) (1015). In some embodiments details of a Mass Production Run (MPR) (1015) may include product information about at least one product, minimum order quantities of at least one product, price of at least one product, supplier information, and shipping information.

System (1010) includes process-memory interface (1017) that allows management process (1016) to access, analyze, add, delete and modify records of purchased fractional parts of Mass Production Runs (MPRs) (1018) that are associated with at least one record in records of Mass Production Runs (MPRs) (1015). In some embodiments records of Mass Production Runs (MPRs) (1015) may reside within the same database as records of purchased fractional parts of Mass Production Runs (MPRs) (1018).

In some embodiments buyer (1040) connects to system (1010) and uses management process (1016) to access, analyze, purchase, modify past purchases of, or cancel past purchases of at least one fractional part of at least one Mass Production Run (MPR) (1018). In some embodiments, management process (1013) connects to buyer (1040) with notifications relevant to at least one record of Mass Production Runs (MPRs) (1015). In some embodiments, management process (1016) connects to buyer (1040) with notifications relevant to at least one record of purchased fractional parts of Mass Production Runs (MPRs) (1018).

In some embodiments supplier (1030) connects to system (1010) and uses management process (1013) to access, analyze, add, modify, or delete records of Mass Production Runs (MPRs) (1015). In some embodiments, management process (1013) connects to supplier (1030) with notification of a relevant change to at least one record of Mass Production Runs (MPRs) (1015). In some embodiments, management process (1016) connects to supplier (1030) with notifications relevant to at least one record of purchased fractional parts of Mass Production Runs (MPRs) (1018).

In some embodiments, buyer (1040) and supplier (1030) may be the same entity.

In some embodiments management process (1016) detects when an aggregate of purchased fractional parts of Mass Production Runs (MPRs) (1018) has reached the Minimum Order Quantity (MOQ) described in the associated record of Mass Production Runs (MPRs) (1015).

### Exemplary Matching Engine Method (1100, 1200)

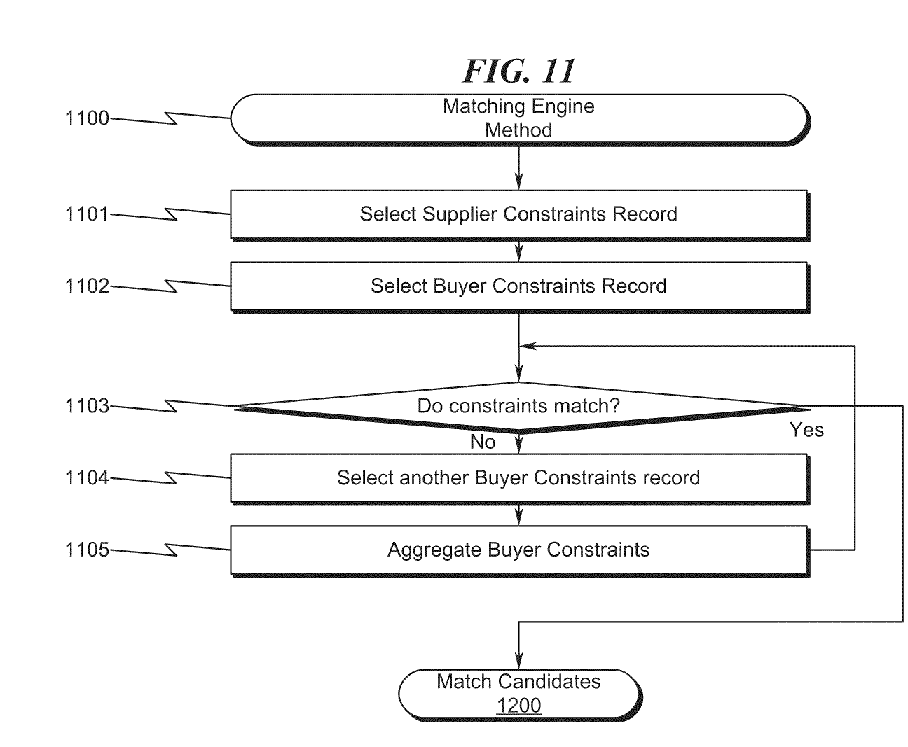

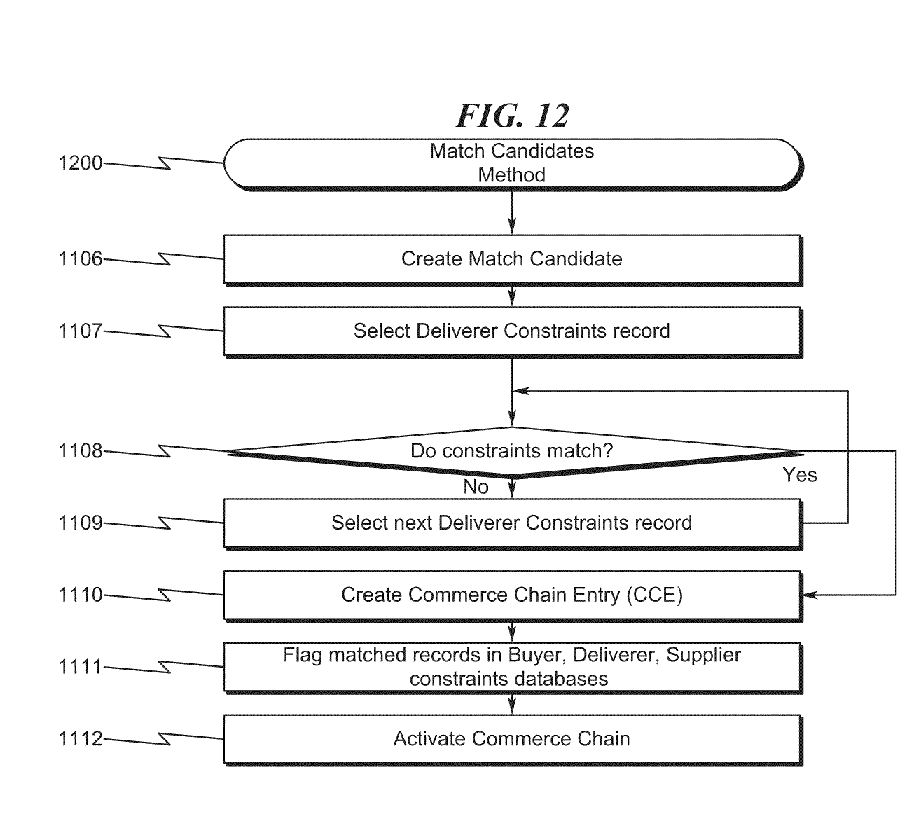

The matching engine component of the present invention in a method embodiment may be generally described by the flowchart of FIG. 11 (1100) and FIG. 12 (1200), wherein the matching engine method comprises the following steps:
(1) selecting a record from the supplier constraint database (1101);
(2) selecting a record from the buyer constraint database (1102);
(3) comparing the selected records to determine whether the constraints in the buyer record match or partially match the constraints in the supplier record (1103);
(4) if the constraints of the selected buyer record do not match, or only partially match the constraints of the supplier record, selecting the next buyer record from the buyer database (1104) that partially matches the constraints of the supplier record, aggregating its constraints and the constraints from the previously selected partially-matched buyer records (1105) and comparing the now aggregated constraints to the supplier record; repeating this process until a match is achieved and a match candidate is created (1106);
(5) selecting a record from the deliverer constraints database (1107);
(6) comparing the match candidate record constraints with the deliverer record constraints (1108);
(7) if the constraints of the match candidate do not match the constraints of the deliverer constraints record, selecting the next record from the deliverer constraints database (1109) and comparing the constraints of this new deliverer constraints record with the constraints of the match candidate (1108); repeating this process until a match is achieved and a commerce chain entry is created (1110);
(8) Flagging all matched records in the supplier, deliverer, and buyer constraints databases (1111); and
(9) activating a commerce chain (1112);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Matching Engine Exemplary Data Flow Example

The following illustrates a numerical example of the matching engine method generally illustrated in flowchart of FIG. 11 (1100) and FIG. 12 (1200):
One supplier enters the following constraint into the Supplier Constraints Database (SCD):
(Product=mountain bike) AND (Color=green) AND (MOQ=40) AND (Shipping Size=20 ft container) AND (Lead time=2 weeks) AND (Shipping Origin=Hong Kong port) AND (Destination=Worldwide)
One buyer enters the following constraint into the Consumer Constraints Database (CCD):
(Product=mountain bike) AND (Color=green) AND (Order Quantity=10) AND (Location=452 Arizona Street, Santa Monica, Calif.)
One buyer enters the following constraint into the Consumer Constraints Database (CCD):
(Product=mountain bike) AND (color=green) AND (Order Quantity=10) AND (Location=Suite 302, 452 Central Park West, New York, N.Y.)
One buyer enters the following constraint into the Consumer Constraints Database (CCD):
(Product=mountain bike) AND (color=green) AND (Order Quantity=20) AND (Location=2614 Balaclava Street, Vancouver, BC, Canada)
One shipper enters the following constraint into the Deliverer Constraints Database (DCD):
(Minimum payload size=0.5 20 ft container) AND (Origin=Hong Kong port) AND (Destination=USA)
One shipper enters the following constraint into the Deliverer Constraints Database (DCD):
(Minimum payload size=0.5 20 ft container) AND (Origin=Hong Kong port) AND (Destination=CANADA)
The matching engine method of FIG. 11 (1100) and FIG. 12 (1200) first selects the supplier record (1101), and the first buyer record (1102). It fails to create a match until it runs through loop (1103, 1104, 1105) three times, each time aggregating constraints of subsequent buyer records. Once three (3) buyer records have been aggregated, the aggregate buyer and supplier constraints match (such that the supplier MOQ, product specifications, and destination match the aggregate buyer order quantity, product specifications, and destinations), and a match candidate is created (1106).
The shipping record is selected (1107) and its constraints and those of the candidate match are compared (1108). It fails to create a match until it runs through loop (1108, 1109, 1110) twice, each time aggregating constraints of subsequent deliverers. Once two deliverer records have been aggregated, the aggregate constraints match those of the match candidate such that two deliverers are each able to ship from the supplier's port to one of each the buyers' destinations, and a Commerce Chain Entry (CCE) is created (1110). The matched records are flagged (1111) and the commerce chain activated (1112).

### Constraint Composition

Each of the constraints associated with the supplier, shipper, and/or consumer may be composed of a set of discrete and/or ranged values linked by Boolean operators. An example that illustrates a buyer constraint that includes discrete and ranged values and compatible supplier and shipper constraints may be given as:
Buyer Constraint:
(Product=bike) AND (Color=Green OR Blue) AND (Price>$0 AND Price<=$100) AND (Destination Address=452 Arizona Street, Santa Monica, Calif., USA) AND (Quantity=1);
Supplier constraint:
(Product=bike) AND (Color=Blue) AND (Price=$75) AND (Destination=Worldwide) AND (MOQ=1);
Shipper constraint:
(Pickup Location=Worldwide) AND (Delivery Location=USA).

An example illustrating a situation where the matching engine has aggregated buyer constraints to match compatible supplier and shipper constraints may be given as:
Buyer 1 Constraint:
(Product=bike) AND (Color=Green OR Blue) AND (Price>$0 AND Price<=$100) AND (Destination Address=452 Arizona Street, Santa Monica, Calif., USA) AND (Quantity=2);
Buyer 2 Constraint:
(Product=bike) AND (Color=Green OR Blue) AND (Price>$0 AND Price<=$100) AND (Destination Address=2614 Balaclava Street, Vancouver, CANADA) AND (Quantity=1);
Supplier constraint:
(Product=bike) AND (Color=Blue) AND (Price=$75) AND (Destination=Worldwide) AND (MOQ=3);
Shipper 1 constraint:
(Pickup Location=Worldwide) AND (Delivery Location=USA);
Shipper 2 constraint:
(Pickup Location=Worldwide) AND (Delivery Location=CANADA).

One skilled in the art will recognize that the composition of a constraint may take many forms and that the forms presented here are only exemplary.

### Commerce Chain Activation/Triggering

The present invention anticipates that once a commerce chain has been created after matching compatible supplier, shipper, and consumer constraints, it may be triggered for activation and execution in a number of ways, including but not limited to activation by the following members:

(1) the supplier;

(2) the deliverer;

(3) the consumer;

(4) the matching engine processor (MEP); and

(5) the mediation processor (MP).

The system/method will optimally utilize automated triggering within the MEP and/or MP to trigger the execution of events within the supplier, deliverer, and consumer. In this fashion, these parties need not have any knowledge of the other parties for the cooperative commerce system to function. The only information needed for each entity to function is provided by the MP, thus allowing a certain degree of anonymity to be maintained between the supplier, deliverer, and consumer.

While a wide variety of communication methodologies may be used to activate execution of the commerce chain entry (CCE), the present invention may make use of electronic communication in the form of e-mail, text message, automated voice messaging, and the like to affect communication to the supplier, deliverer, and/or consumer.

### Exemplary Consumer User Interface (CUI) (1300, 1400, 1500)

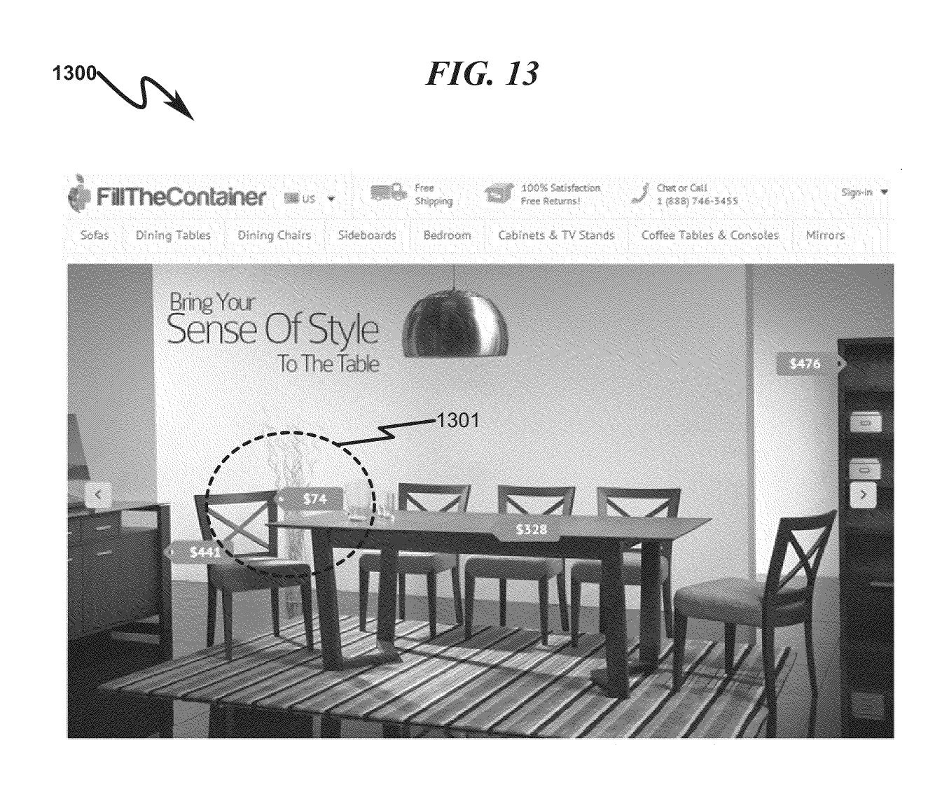

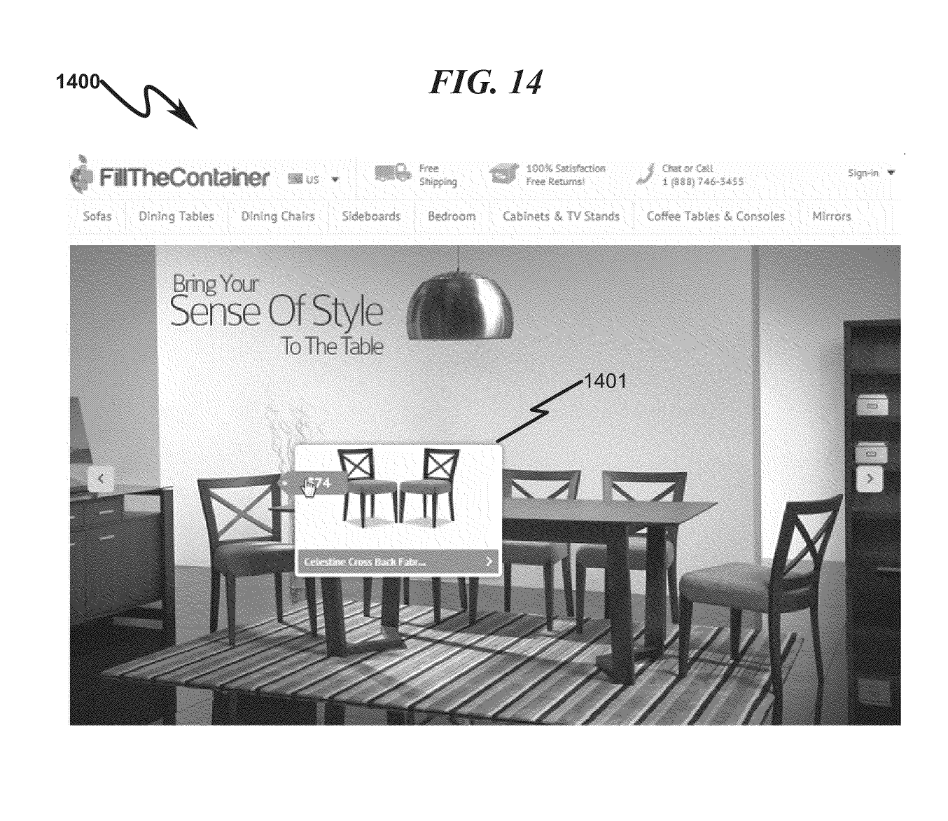

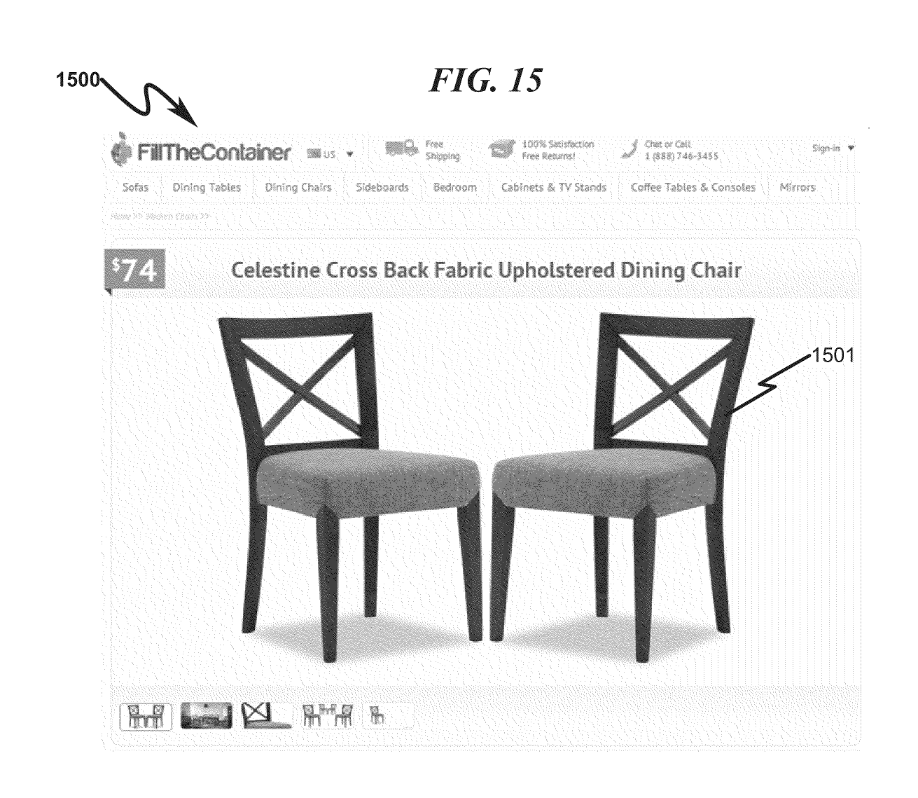

An exemplary consumer user interface (CUI) useful in some preferred embodiments of the present system is generally illustrated in FIG. 13 (1300), FIG. 14 (1400), and FIG. 15 (1500).

FIG. 13 (1300) illustrates how a typical consumer user interface (CUI) may operate by displaying PUSH advertising from a supplier who wishes to sell furniture. In this scenario, a typical complement of product is displayed having context-sensitive information (1301) describing pricing for a given product within the overall display. This context-sensitive information (1301) may then be selected to produce a product identification page as shown in FIG. 14 (1400) that indicates more information on the selected product (1401). This additional information may be then used as the basis of an additional user selection that generates a product detail screen as depicted in FIG. 15 (1500) in which product details (1501) are displayed. At any point in this process the user may opt to purchase the product or select another product within the overall product display to obtain additional product information.

### Shipping Container Status (1600)

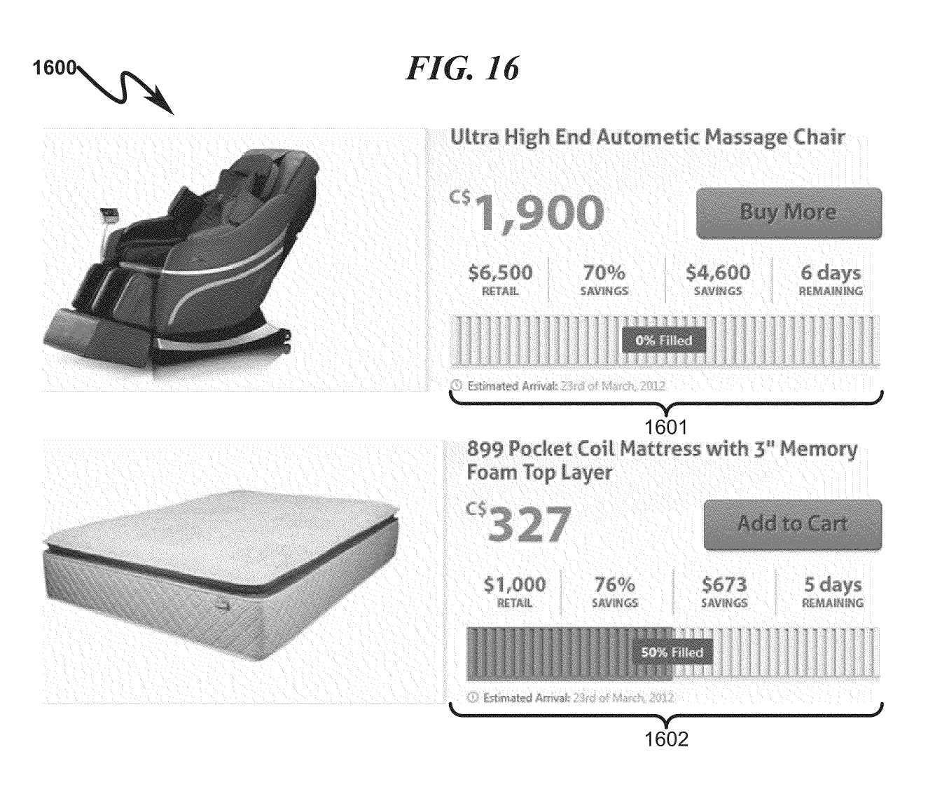

One Consumer User Interface (CUI) detail screen that may be implemented in some preferred system/method embodiments incorporates the use of a shipping container status display as generally illustrated in FIG. 16 (1600), wherein as consumers purchase individual products, the “filled” status of the shipping containers is displayed in real-time (1601, 1602) in addition to information regarding when the purchased items will be available for consumer delivery. In this manner, a consumer may be given notice as to when a potential container may ship and when their purchased (or potentially purchased) product may be available for delivery. In this manner the consumer has a viewport into the manufacturing and delivery schedule of product availability and as such can make a more informed decision on if or when to make a product purchase.

### System Summary

The present invention system anticipates a wide variety of variations in the basic theme of construction, but can be generalized as a consumer-shipper-supplier mediation system comprising:
(a) supplier user interface (SUI);
(b) deliverer user interface (DUI);
(c) consumer user interface (CUI);
(d) supplier constraints database (SCD);
(e) deliverer constraints database (DCD);
(f) consumer constraints database (CCD);
(g) mediation processor (MP);
(h) matching engine processor (MEP); and
(i) commerce chain database (CHD);
wherein
the SUI is configured to operate under control of the MP and accept supplier constraints (SC) describing constraints associated with production of goods for a supplier;
the DUI is configured to operate under control of the MP and accept deliverer constraints (DC) describing constraints associated with delivery of goods for a shipper;
the CUI is configured to operate under control of the MP and accept consumer constraints (CC) describing purchasing constraints for a consumer;
the MP is configured to store the SC in the SCD;
the MP is configured to store the DC in the DCD;
the MP is configured to store the CC in the CCD;
the MEP is configured to compare constraints stored in the SCD, the DCD, and the CCD;
the MEP is configured to determine if a compatible set of constraints can be matched based on the comparison;
the MEP is configured to create a commerce chain entry (CCE) in the CHD based on the matching;
the CCE comprises activity to be executed by the supplier, the deliverer, and the consumer; and
the MP is configured to initiate execution of the activity by the supplier, the deliverer, and the consumer when the CCE is triggered.

This general system summary may be augmented by the various elements described herein to produce a wide variety of invention embodiments consistent with this overall design description.

### Method Summary

The present invention method anticipates a wide variety of variations in the basic theme of implementation, but can be generalized as a consumer-shipper-supplier mediation method, the method executed on a computerized consumer-shipper-supplier mediation system, the system comprising:
(a) supplier user interface (SUI);
(b) deliverer user interface (DUI);
(c) consumer user interface (CUI);
(d) supplier constraints database (SCD);
(e) deliverer constraints database (DCD);
(f) consumer constraints database (CCD);
(g) mediation processor (MP);
(h) matching engine processor (MEP); and
(i) commerce chain database (CHD);
wherein the method comprises the steps of:
(1) under control of the MP, the SUI accepts supplier constraints (SC) describing constraints associated with production of goods for a supplier;
(2) under control of the MP, the DUI accepts deliverer constraints (DC) describing constraints associated with delivery of goods for a shipper;
(3) under control of the MP, the CUI accepts consumer constraints (CC) describing purchasing constraints for a consumer;
(4) the MP stores the SC in the SCD;
(5) the MP stores the DC in the DCD;
(6) the MP stores the CC in the CCD;
(7) the MEP compares constraints stored in the SCD, the DCD, and the CCD to determine if a compatible set of constraints can be matched, and if so, creates a commerce chain entry (CCE) in the CHD, wherein the CCE comprises activity to be executed by the supplier, the deliverer, and the consumer; and
(8) the MP initiates execution of the activity by the supplier, the deliverer, and the consumer as defined by the CHD.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the triggering is initiated by a member selected from a group consisting of:
(1) the supplier;
(2) the deliverer;
(3) the consumer;
(4) the MEP; and
(5) the MP.
An embodiment wherein the trigger is configured to be initiated by communication with the MP, via the supplier through the SUI, the deliverer through the DUI, or the consumer through the CUI.
An embodiment wherein the SUI, the DUI, and the CUI further comprise a web interface that communicates with the MP over the Internet.
An embodiment wherein the MP further comprises the MEP.
An embodiment wherein the SUI further comprises the DUI and the SCD further comprises the DCD.
An embodiment wherein the CUI further comprises the DUI and the CCD further comprises the DCD.
An embodiment wherein the CCE further comprises a chain of CCE elements, wherein the CCE elements link a consumer to a subsequent supplier within the chain.
An embodiment wherein the CCE further comprises a nested chain of CCE elements, wherein each supplier, deliverer, and consumer within the nested chain may be represented by a tree of one or more suppliers, deliverers, and consumers.
An embodiment wherein the SC, the DC, and the CC further comprise a set of discrete and ranged values linked by Boolean operators.
An embodiment wherein the SC is selected from a group consisting of:
(1) product identification;
(2) product specifications;
(3) product regulatory information;
(4) manufacturing regulatory information;
(5) manufacturer location;
(6) manufacturer financial information;
(7) manufacturer order information;
(8) manufacturer profit;
(9) shipping terms;
(10) packaged product shipping volume/weight;
(11) shipping container volume;
(12) order quantity;
(13) Minimum Order Quantity (MOQ);
(14) production line setup time;
(15) raw material lead time;
(16) product production time;
(17) price-per-unit;
(18) cost-per-unit; and
(19) an algebraic function of manufacturing parameters.
An embodiment wherein the DC is selected from a group consisting of:
(1) shipping terms;
(2) authorized shipping contractor;
(3) shipping insurance;
(4) shipping time;
(5) origin;
(6) destination;
(7) shipping container class;
(8) shipping capacity;
(9) transporter availability;
(10) shipping transporter delay;
(11) transporter capacity;
(12) shipping price-per-unit;
(13) shipping price-per-unit volume;
(14) shipping price-per-unit weight;
(15) associated shipping costs; and
(16) an algebraic function of shipping parameters.
An embodiment wherein the CC is selected from a group consisting of:
(1) product identification;
(2) product specifications;
(3) unit quantity;
(4) lead time;
(5) price-per-unit;
(6) shipping terms;
(7) shipment origin;
(8) shipment destination;
(9) shipping costs;
(10) total price-per-unit; and
(11) an algebraic function of consumer parameters.
An embodiment wherein the SUI is configured to operate on records in the SCD using a function selected from a group consisting of:
(1) access;
(2) analysis;
(3) add;
(4) delete; and
(5) modify.
An embodiment wherein the DUI is configured to operate on records in the DCD using a function selected from a group consisting of:
(1) access;
(2) analysis;
(3) add;
(4) delete; and
(5) modify.
An embodiment wherein the CUI is configured to operate on records in the CCD using a function selected from a group consisting of:
(1) access;
(2) analysis;
(3) add;
(4) delete; and
(5) modify.
An embodiment wherein the supplier and the consumer are the same entity.

One skilled in the art will recognize that other embodiments are possible based on combinations of elements taught within the above invention description.

### Exemplary Embodiment Advantages

While the present invention may be embodied in many forms, each having specific advantages over the prior art, the following are some potential advantages that may be obtained in some preferred exemplary embodiments of the present invention:
The invention presents many significant advantages over existing supply chains. Buyers can purchase products from a supplier at a price equal or close to that supplier's cost of production rather than at a higher price. Prices are naturally kept low since products do not need to be stocked or produced before they are purchased. Suppliers do not need to maintain inventory of their products, nor anticipate demand.
Suppliers can sell Mass Production Runs (MPRs) of products to a larger market than just people or organizations capable of making purchases large enough to meet or exceed that supplier's Minimum Order Quantity (MOQ). The invention provides for a plurality of buyers, each purchasing small quantities of products directly from suppliers rather than from wholesalers or other entities. Individual buyers can purchase small quantities of a product or products at a per-unit price equal or close to that of the per-unit price of a complete mass production run of that product or those products. Furthermore, suppliers do not need to reduce their minimum order quantities to sell to buyers with limited buying-power. In fact, the invention provides a mechanism by which suppliers can increase their Minimum Order Quantity (MOQ) to decrease their cost-per-unit.
The invention may allow suppliers to increase their per-unit prices while providing a better price to potential buyers than wholesalers, distributors, retailers, or other entities.
The invention provides for an extremely efficient product fulfillment process such that products are shipped directly to buyers without requiring storage, handling, and display costs typically associated with wholesale and retail.
Another advantage of the invention is that resellers can sell products before ordering the products from suppliers.
Another advantage of the invention is that demand can be assessed for a product before ordering or producing that product.
Another advantage of the invention is that suppliers can minimize wasted inventory or production capacity.
   One skilled in the art will recognize that this list is non-exhaustive and only exemplary of the benefits of some preferred invention embodiments.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A consumer-shipper-supplier mediation system/method that coordinates the ordering, production, and delivery of products between consumers and suppliers has been disclosed. The system/method allows consumers to aggregate orders for product manufacturing and mediate these product order requests to suppliers and shippers who can then match product manufacturing, shipping, and consumer constrainers. The system/method also permits symmetric operation to allow suppliers to schedule product production and optimize price-per-unit by using PUSH advertising to prospective consumers who have placed tentative orders for products that have yet to be manufactured or are not yet needed. In some preferred embodiments the mediation system/method incorporates a shipping interface to permit shippers to be fully integrated within the consumer-shipper-supplier commerce chain. The system/method in some preferred embodiments matches consumer-shipper-supplier constraints while simultaneously maximizing supplier-shipper pricing margins and minimizing consumer delivered product costs.

The present invention in some preferred embodiments provides a system and method for selling mass production runs. The method involves using Minimum Order Quantity (MOQ) information provided by a supplier of goods to create a set of production offers, the aggregate of which equals the minimum order requirements of the supplier, selling those production offers to a group of potential buyers until the aggregate meets the minimum requirements of the supplier, placing an order with the supplier that meets the Minimum Order Quantity (MOQ) requirements, then managing fulfillment to each of the buyers of the production offers.

The present invention in some preferred embodiments provides a system and method that allows manufacturers of goods, “suppliers”, to sell fractional parts of Mass Production Runs (MPRs) to one or more buyers such that the aggregate sale satisfies that supplier's Minimum Order Quantity, “MOQ”. This preferred embodiment allows suppliers to secure orders for their products from one or more buyers (that may or may not be related to one another) such that the aggregate of the orders meets or exceeds that supplier's Minimum Order Quantity. Furthermore, it allows buyers who may otherwise not need or be able to afford a supplier's Minimum Order Quantity to group together with like-buyers to purchase production orders directly from suppliers.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A consumer-shipper-supplier mediation system comprising:
(a) supplier user interface (SUI);
(b) deliverer user interface (DUI);
(c) consumer user interface (CUI);
(d) supplier constraints database (SCD);
(e) deliverer constraints database (DCD);
(f) consumer constraints database (CCD);
(g) mediation processor (MP);
(h) matching engine processor (MEP); and
(i) commerce chain database (CHD);
wherein
said SUI is configured to operate under control of said MP and accept supplier constraints (SC) describing constraints associated with production of goods for a supplier;
said DUI is configured to operate under control of said MP and accept deliverer constraints (DC) describing constraints associated with delivery of goods for a shipper;
said CUI is configured to operate under control of said MP and accept consumer constraints (CC) describing purchasing constraints for a consumer;
said MP is configured to store said SC in said SCD;
said MP is configured to store said DC in said DCD;
said MP is configured to store said CC in said CCD;
said MEP is configured to compare constraints stored in said SCD, said DCD, and said CCD;
said MEP is configured to determine if a compatible set of constraints can be matched based on said comparison;
said MEP is configured to create a commerce chain entry (CCE) in said CHD based on said matching;
said CCE comprises activity to be executed by said supplier, said deliverer, and said consumer; and
said MP is configured to initiate execution of said activity by said supplier, said deliverer, and said consumer when said CCE is triggered.

2. The consumer-shipper-supplier mediation system of claim 1 wherein said trigger is initiated by a member selected from a group consisting of:
(1) said supplier;
(2) said deliverer;
(3) said consumer;
(4) said MEP; and
(5) said MP.

3. The consumer-shipper-supplier mediation system of claim 1 wherein said SUI, said DUI, and said CUI further comprise a web interface that communicates with said MP over the Internet.

4. The consumer-shipper-supplier mediation system of claim 1 wherein said MP further comprises said MEP.

5. The consumer-shipper-supplier mediation system of claim 1 wherein said SUI further comprises said DUI and said SCD further comprises said DCD.

6. The consumer-shipper-supplier mediation system of claim 1 wherein said CUI further comprises said DUI and said CCD further comprises said DCD.

7. The consumer-shipper-supplier mediation system of claim 1 wherein said CCE further comprises a chain of CCE elements, wherein said CCE elements link a consumer to a subsequent supplier within said chain.

8. The consumer-shipper-supplier mediation system of claim 1 wherein said CCE further comprises a nested chain of CCE elements, wherein each supplier, deliverer, and consumer within said nested chain may be represented by a tree of one or more suppliers, deliverers, and consumers.

9. The consumer-shipper-supplier mediation system of claim 1 wherein said SC, said DC, and said CC further comprise a set of discrete and ranged values linked by Boolean operators.

10. The consumer-shipper-supplier mediation system of claim 1 wherein said SC is selected from a group consisting of:
(1) product identification;
(2) product specifications;
(3) product regulatory information;
(4) manufacturing regulatory information;
(5) manufacturer location;
(6) manufacturer financial information;
(7) manufacturer order information;
(8) manufacturer profit;
(9) shipping terms;
(10) packaged product shipping volume/weight;
(11) shipping container volume;
(12) order quantity;
(13) Minimum Order Quantity (MOQ);
(14) production line setup time;
(15) raw material lead time;
(16) product production time;
(17) price-per-unit;
(18) cost-per-unit; and
(19) an algebraic function of manufacturing parameters.

11. The consumer-shipper-supplier mediation system of claim 1 wherein said DC is selected from a group consisting of:
(1) shipping terms;
(2) authorized shipping contractor;
(3) shipping insurance;
(4) shipping time;
(5) origin;
(6) destination;
(7) shipping container class;
(8) shipping capacity;
(9) transporter availability;
(10) shipping transporter delay;
(11) transporter capacity;
(12) shipping price-per-unit;
(13) shipping price-per-unit volume;
(14) shipping price-per-unit weight;
(15) associated shipping costs; and
(16) an algebraic function of shipping parameters.

12. The consumer-shipper-supplier mediation system of claim 1 wherein said CC is selected from a group consisting of:
(1) product identification;
(2) product specifications;
(3) unit quantity;
(4) lead time;
(5) price-per-unit;
(6) shipping terms;
(7) shipment origin;
(8) shipment destination;
(9) shipping costs;
(10) total price-per-unit; and
(11) an algebraic function of consumer parameters.

13. The consumer-shipper-supplier mediation system of claim 1 wherein said SUI is configured to operate on records in said SCD using a function selected from a group consisting of:
(1) access;
(2) analysis;
(3) add;
(4) delete; and
(5) modify.

14. The consumer-shipper-supplier mediation system of claim 1 wherein said DUI is configured to operate on records in said DCD using a function selected from a group consisting of:
(1) access;
(2) analysis;
(3) add;
(4) delete; and
(5) modify.

15. The consumer-shipper-supplier mediation system of claim 1 wherein said CUI is configured to operate on records in said CCD using a function selected from a group consisting of:
(1) access;
(2) analysis;
(3) add;
(4) delete; and
(5) modify.

16. The consumer-shipper-supplier mediation system of claim 1 wherein said supplier and said consumer are the same entity.

17. A consumer-shipper-supplier mediation method, said method executed on a computerized consumer-shipper-supplier mediation system, said system comprising:
(a) supplier user interface (SUI);
(b) deliverer user interface (DUI);
(c) consumer user interface (CUI);
(d) supplier constraints database (SCD);
(e) deliverer constraints database (DCD);
(f) consumer constraints database (CCD);
(g) mediation processor (MP);
(h) matching engine processor (MEP); and
(i) commerce chain database (CHD);
wherein said method comprises the steps of:
(1) under control of said MP, said SUI accepts supplier constraints (SC) describing constraints associated with production of goods for a supplier;
(2) under control of said MP, said DUI accepts deliverer constraints (DC) describing constraints associated with delivery of goods for a shipper;
(3) under control of said MP, said CUI accepts consumer constraints (CC) describing purchasing constraints for a consumer;
(4) said MP stores said SC in said SCD;
(5) said MP stores said DC in said DCD;
(6) said MP stores said CC in said CCD;
(7) said MEP compares constraints stored in said SCD, said DCD, and said CCD to determine if a compatible set of constraints can be matched, and if so, creates a commerce chain entry (CCE) in said CHD, wherein said CCE comprises activity to be executed by said supplier, said deliverer, and said consumer; and
(8) said MP initiates execution of said activity by said supplier, said deliverer, and said consumer as defined by said CHD.

18. The consumer-shipper-supplier mediation method of claim 17 wherein said trigger is initiated by a member selected from a group consisting of:
(1) said supplier;
(2) said deliverer;
(3) said consumer;
(4) said MEP; and
(5) said MP.

19. The consumer-shipper-supplier mediation method of claim 17 wherein said SUI, said DUI, and said CUI further comprise a web interface that communicates with said MP over the Internet.

20. The consumer-shipper-supplier mediation method of claim 17 wherein said MP further comprises said MEP.

21. The consumer-shipper-supplier mediation method of claim 17 wherein said SUI further comprises said DUI and said SCD further comprises said DCD.

22. The consumer-shipper-supplier mediation method of claim 17 wherein said CUI further comprises said DUI and said CCD further comprises said DCD.

23. The consumer-shipper-supplier mediation method of claim 17 wherein said CCE further comprises a chain of CCE elements, wherein said CCE elements link a consumer to a subsequent supplier within said chain.

24. The consumer-shipper-supplier mediation method of claim 17 wherein said CCE further comprises a nested chain of CCE elements, wherein each supplier, deliverer, and consumer within said nested chain may be represented by a tree of one or more suppliers, deliverers, and consumers.

25. The consumer-shipper-supplier mediation method of claim 17 wherein said SC, said DC, and said CC further comprise a set of discrete and ranged values linked by Boolean operators.

26. The consumer-shipper-supplier mediation method of claim 17 wherein said SC is selected from a group consisting of:
(1) product identification;
(2) product specifications;
(3) product regulatory information;
(4) manufacturing regulatory information;
(5) manufacturer location;
(6) manufacturer financial information;
(7) manufacturer order information;
(8) manufacturer profit;
(9) shipping terms;
(10) packaged product shipping volume/weight;
(11) shipping container volume;
(12) order quantity;
(13) Minimum Order Quantity (MOQ);
(14) production line setup time;
(15) raw material lead time;
(16) product production time;
(17) price-per-unit;
(18) cost-per-unit; and
(19) an algebraic function of manufacturing parameters.

27. The consumer-shipper-supplier mediation method of claim 17 wherein said DC is selected from a group consisting of:
(1) shipping terms;
(2) authorized shipping contractor;
(3) shipping insurance;
(4) shipping time;
(5) origin;
(6) destination;
(7) shipping container class;
(8) shipping capacity;
(9) transporter availability;
(10) shipping transporter delay;
(11) transporter capacity;
(12) shipping price-per-unit;
(13) shipping price-per-unit volume;
(14) shipping price-per-unit weight;
(15) associated shipping costs; and
(16) an algebraic function of shipping parameters.

28. The consumer-shipper-supplier mediation method of claim 17 wherein said CC is selected from a group consisting of:
(1) product identification;
(2) product specifications;
(3) unit quantity;
(4) lead time;
(5) price-per-unit;
(6) shipping terms;
(7) shipment origin;
(8) shipment destination;
(9) shipping costs;
(10) total price-per-unit; and
(11) an algebraic function of consumer parameters.

29. The consumer-shipper-supplier mediation method of claim 17 wherein said SUI is configured to operate on records in said SCD using a function selected from a group consisting of:
(1) access;
(2) analysis;
(3) add;
(4) delete; and
(5) modify.

30. The consumer-shipper-supplier mediation method of claim 17 wherein said DUI is configured to operate on records in said DCD using a function selected from a group consisting of:
(1) access;
(2) analysis;
(3) add;
(4) delete; and
(5) modify.

31. The consumer-shipper-supplier mediation method of claim 17 wherein said CUI is configured to operate on records in said CCD using a function selected from a group consisting of:
(1) access;
(2) analysis;
(3) add;
(4) delete; and
(5) modify.

32. The consumer-shipper-supplier mediation method of claim 17 wherein said supplier and said consumer are the same entity.
